(19) United States
(12) Patent Application Publication
(10) Pub. No.: US 2013/0073337 A1
(43) Pub. Date: Mar. 21, 2013

(54) System and method for merchandise selection based on Location and produce trials

(71) Applicants: Bo Wu, Beijing (CN); Chonghao Jiang, Beijing (CN); Guohua Lu, Beijing (CN); Yuhong Xiong, Beijing (CN)

(72) Inventors: Bo Wu, Beijing (CN); Chonghao Jiang, Beijing (CN); Guohua Lu, Beijing (CN); Yuhong Xiong, Beijing (CN)

(73) Assignee: LaShou Group INC.

(21) Appl. No.: 13/200,223

(22) Filed: Sep. 20, 2011

(51) Int. Cl. G06Q 10/04; G06Q 30/02

(52) U.S. Cl. 705/7.31

(57) ABSTRACT

A merchandise selection system comprises a merchandise trial selection module, a sales volume prediction module, and a targeted selling module. The trial selection module determines a set of trial parameters including city information, product information, price information, and trial period information. The sales volume prediction module determines estimated sales volume for a product during a sales period in a selected city based on trial result. The targeted selling module determines to feature the product for the sales period in the selected city if the estimated sales volume meets a threshold. The merchandise selection system provides better prediction result, facilitates precise planning, and enables better control of shelf space in each city.

### TECHNICAL FIELD

The present invention relates generally to e-commerce and, more particularly, to system and method for merchandise selection process.

### BACKGROUND

In retailing business, a retailer needs to decide what products to sell and the quantity of the selected products to get from its upstream suppliers (e.g., wholesalers or manufacturers). For national or multi-national retailing chains, the problem is more complicated. The retailer not only needs to determine whether to sell a certain product and the total amount of the selected product to get, but also whether to sell the product in a certain region and the amount to stock up in that region. Traditionally, retailers select merchandise based on experience, market information, and historic sales data. However, bad decisions are still made inevitably, causing unsold inventories to pile up, which further causes profit reduction or loss.

For online retailers, e-commerce helps to solve part of the problem. In standard online retailing, a number of large central warehouses are built for stocking merchandise. An online retailer procures merchandise from manufacturers and wholesalers, and stocks them in a central warehouse. The ordered product is then shipped from the central warehouse to the buyer. This way, the online retailer does not need to predict the quantity of a product for each region, but still needs to estimate the total quantity before deciding to sell the product.

In general, both traditional retailing and standard B2C online retailing follow a two-phase process in doing retail business. The first phase is the merchandise selection phase. During the first phase, a retailer or e-tailer uses experience, market information, and historic sales data to determine which product to sell, and in most cases, also how much to buy from its upstream supplier. The second phase is the trading phase. During the second phase, if the retailer or e-tailer decides to sell a certain product, it buys a certain quantity from the supplier and sells the product either in store or online via the Internet to its customers.

While the merchandise selection phase is very critical, it is very difficult for a retailer or e-tailer to accurately predict/estimate the right product with the right amount. Although comprehensive methods may be applied for making the right merchandise selection choice, too many factors could go wrong to make potentially good decisions becoming bad ones. When a wrong product is selected, or when the quantity to be sold is underestimated or overestimated, the retailer may suffer severe profit reduction or loss.

### SUMMARY

An online group-buying system with merchandise selection mechanism is provided. The merchandise selection system comprises a merchandise trial selection module, a sales volume prediction module, and a targeted selling module. The trial selection module determines a set of trial parameters including city information, product information, price information, and trial period information. The sales volume prediction module determines estimated sales volume for a product during a sales period in a selected city. The estimated sales volume is predicted based on a trial volume of the product sold during a trial period in a trial city. The targeted selling module determines to feature the product for the sales period in the selected city if the estimated sales volume meets a threshold.

In one embodiment, the merchandise selection system is used to select the best-selling cities for a given product. A subset of cities is first selected to do the trial, and the trial result can be used to predict potential sales in all the cities. The trial period is determined for each product in each city depending upon a various factors, and can be fixed before the trial or dynamically adjusted as the trial goes on. In another embodiment, the merchandise selection system is used to select the best-selling products for a given city. The best-selling products may also be featured nationwide. If the nationwide sale of a product reaches certain level, then the product can be featured again nationwide. In addition, the product can be featured repeatedly in some best-selling cities after the product has reached its limit nationwide. In yet another embodiment, the merchandise selection system is used to sell a product at an optimized price, which ensures that an online retailer can make desirable profit while the product can be supplied with the best quality and service.

The merchandise selection system provides more accurate and reliable sales volume prediction result. With more precise sales volume prediction, an online group-buying company can negotiate better terms with its suppliers by making guarantees for a minimum sale. Better prediction will also reduce unsold inventory. Precise sales volume prediction can also enhance planning and facilitate optimized distribution of work load and scheduling. Furthermore, better prediction of sales volume enables better control of the number of products to be featured at city level (optimizing shelf space).

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an online group-buying system in accordance with one novel aspect.

FIG. 2 illustrates a novel merchandise selection and trial process in online group-buying system.

FIG. 3 is a table that illustrates multiple phases in a first embodiment of a novel merchandise selection and trial process.

FIG. 4 is a diagram of past sales data of a product in two cities.

FIG. 5 is a flow chart of a method of selecting the best-selling cities for a certain product as illustrated in FIG. 3.

FIG. 6 is a table that illustrates multiple phases in a second embodiment of a novel merchandise selection and trial process.

FIG. 7 is a flow chart of a method of selecting the best-selling products for a certain city as illustrated in FIG. 6.

FIG. 8 illustrates one advantage of a novel merchandise selection and trial process.

FIG. 9 illustrates another advantage of a novel merchandise selection and trial process.

### DETAILED DESCRIPTION

Reference will now be made in detail to some embodiments of the invention, examples of which are illustrated in the accompanying drawings.

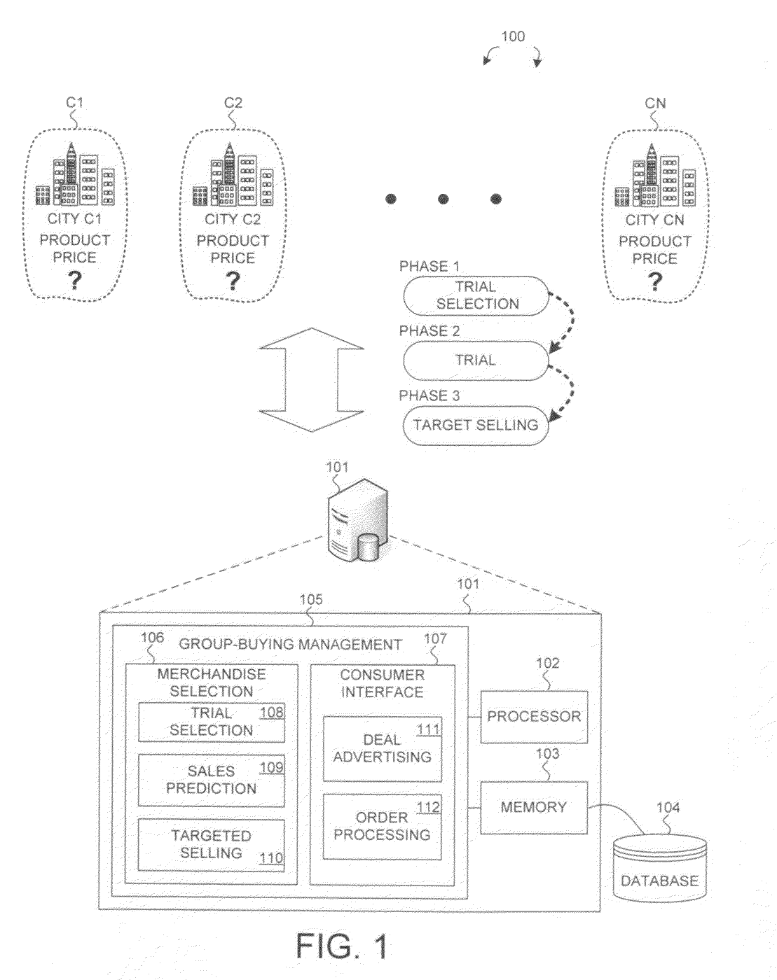

FIG. 1 illustrates an online group-buying system 100 for a plurality of locations in accordance with one novel aspect. Online group-buying system 100 comprises a server computer 101 and a plurality of locations (e.g., cities C1, C2 . . . CN) that provide online group-buying service to consumers. In one novel aspect, online group-buying system 100 adopts a three-phase merchandise trial selection-trial-targeted selling process to optimize the group-buying service. In a first phase of trial selection, certain products are featured in certain cities for short trial periods. Decisions are made as to what products to try, where to try, and for how long to try in the trial selection phase based on experience, market data, and historic sales data. In a second phase of trial, the selected products are featured in the selected cities and sold to consumers during the trial periods. Finally, in a third phase of targeted selling, based on the trial result obtained from the trail phase, decisions are made as to what products to sell, where to sell, and how much to sell in each city.

In the example of FIG. 1, an online retailer utilizes server computer 101 to provide optimized group-buying service to consumers. Server computer 101 comprises a processor 102, memory 103 coupled to a permanent database 104, and an online group-buying management module 105 comprising a merchandise selection interface 106 and a consumer interface 107. Merchandise selection interface 106 comprises a trial selection module 108, a sales volume prediction module 109, and a targeted selling module 110. Trial selection module 108 determines what merchandise to try, which city to try, and for how long to try. Based on the trail result, sales volume prediction module 109 predicts estimated sales volume of a particular product in a particular city. Based on the estimated sales volume, targeted selling module 110 determines what product to sell, which city to cell, and how much to sell in each city. Consumer interface 107 comprises a deal-advertising module 111 and an order-processing module 112. Deal-advertising module 111 advertises selected products to consumers in selected cities via various group-buying websites. Order-processing module 112 receives and processes purchase orders from the consumers. The same deal-advertising and order-processing module may be used for both trial and regular sale.

The different modules within group-buying management module 105 are function modules that may be running on the same or different computer servers. For example, while the merchandise selection interface may be running on a central server computer, each city may be equipped with its own server computer to run a corresponding consumer interface. The function modules, when executed by processor 102, allow the online retailer to select various products to be tried in different cities, to predict sales volume based on trial result, and to sell potentially the best products in the best cities to consumers. All the activities performed and all the information created and updated related to all the business transactions are saved by server computer 101 onto DB 104 for future use.

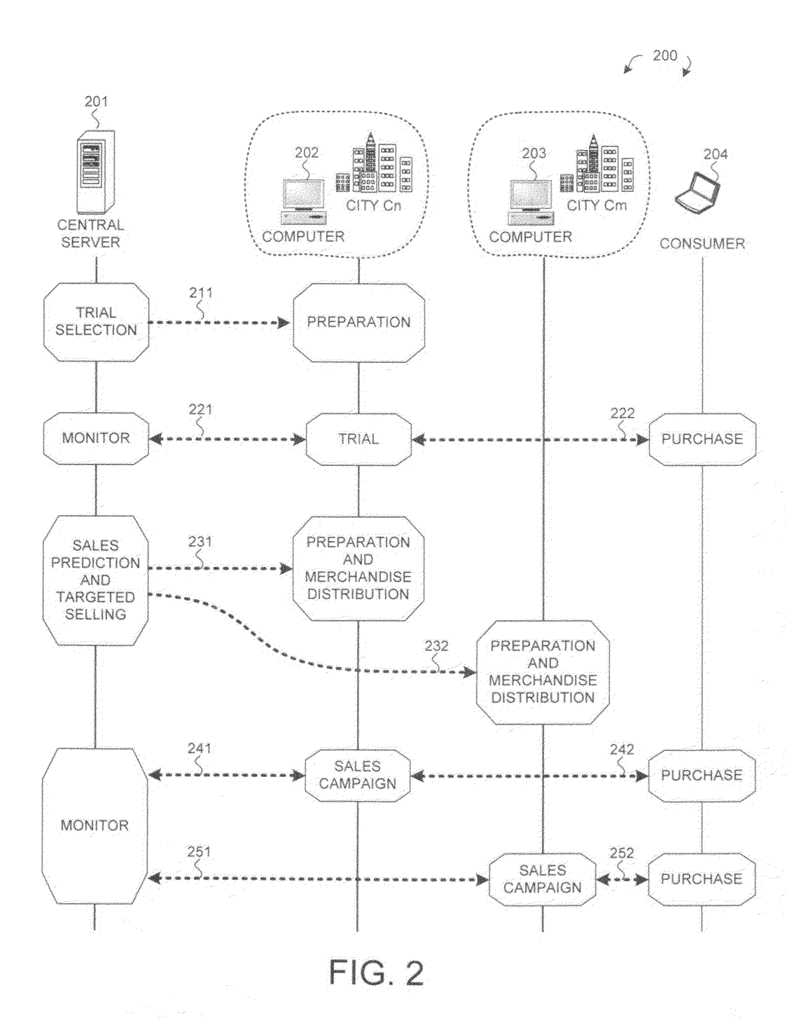

FIG. 2 illustrates a novel merchandise selection and trial process in online group-buying system 200. Online group-buying system 200 comprises a central server computer 201 used by an online retailer, and a plurality of server computers for a plurality of locations (e.g., city Cn and Cm as illustrated in FIG. 2) that provide online group-buying service to consumers. In step 211, server 201 determines a set of trial parameters for a trial process and sends relevant information to the cities that are selected for the trial process. The set of trial parameters may include, but are not limited to: a list of products for the trial, a list of cities for the trial, price and quantity information of the products, and trial period information. If city Cn is selected as one of the cities to participate in the trial, then server 201 sends product, price, quantity, and trial period information to server computer 202 in city Cn to launch the trial process. Based on the received information, the online retailer may start preparation for the trial in the selected cities. For example, the online retailer starts to design a webpage for the selected products so that the website can be timely launched for the trial. In step 221, the selected products are featured to consumers in the selected cities (e.g., city Cn) for a very short trial period. In step 222, consumers purchase the feature products during the trial. The trial process is monitored via server 201, e.g., the number of products sold to consumers is recorded by server 201 as trial result.

Based on the trial result, in step 231 and step 232, server 201 predicts estimated sales volume of the featured products in the selected cities (e.g., city Cn) or in other cities that have sales correlation to the selected cities (e.g., city Cm). If the estimated sales volume of a featured product in a city is above a threshold level, then that city is selected for targeted selling of that featured product for a relatively longer regular sale period. For example, if both city Cn and city Cm is selected, then server 201 sends product, price, estimated quantity, and sale period information to server computer 202 in city Cn and server computer 203 in city Cm to launch the regular group-buying sales process. Based on the received information, the online retailer may start preparation for the targeted selling in the selected cities. Furthermore, based on the estimated quantity information, the online retailer may also start merchandise distribution process to facilitate fast and efficient delivery before the targeted selling even starts. For example, if a product P is estimated to have a sales volume of Qn in city Cn, then quantity Qn of product P is moved from warehouses or directly from upstream suppliers (e.g., wholesalers or manufactures) to distribution centers in city Cn before consumers place orders.

In step 241 and step 251, once the trial has been completed and the decision of targeted selling has been made, the online retailer starts its regular group-buying sales campaign in the selected cities and monitors the sale process and sales result in each city. In step 242, consumers purchase the featured products during the sales campaign in city Cn, and in step 252, consumers in purchase the featured products during the sales campaign in city Cm. These group-buying activities are regular online retailing activities. Because of the novel merchandise selection and trial process occurs prior to the regular group-buying sales process, however, better sales volume prediction can be utilized to facilitate the group-buying business with optimized business objectives.

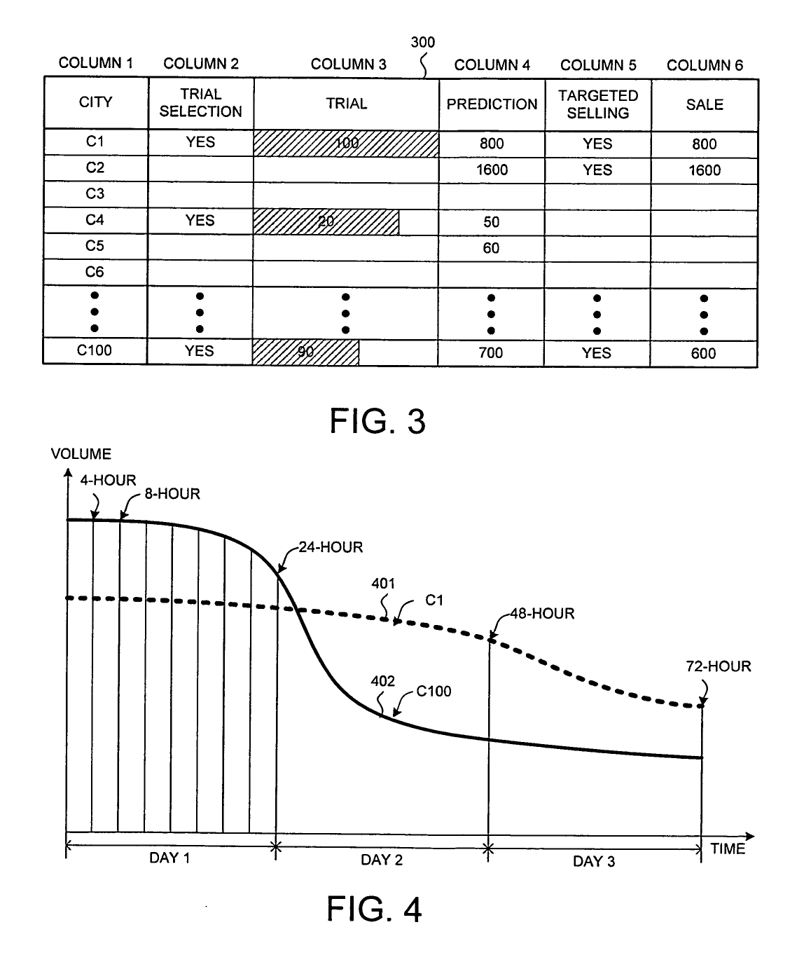

FIG. 3 is a table 300 that illustrates multiple phases in a first embodiment of a novel merchandise selection and trial process. In the first embodiment, the merchandise selection and trial process is used to determine the best cities to sell a certain product. In the example of table 300, an online retailer decides to sell a product in the best cities from one hundred cities C1 to C100, and each row represents a city. The first column lists the city name, the second column indicates whether a city is selected for a trial, the third column illustrates the trial process and trial result, the fourth column lists estimated sales volume predicted for each city, the fifth column indicates whether a city is selected for regular sale, and the sixth column lists the actual sales volume in each selected city.

As illustrated in FIG. 3, cities C1, C4 . . . and C100 are selected from the one hundred cities C1 to C100 to participate in a trial of selling a certain product P. The trial period in each city is very short as compared with the duration that product P is usually featured on a group-buying website. For example, if product P is usually sold for three days, then the trial period can be as short as four hours, as long as the trial result can be used to predict potential sales at a certain precision level. For example, for an inexpensive or commodity product, the trial period may be shorter because buyers are able to make quick decisions. On the other hand, for an expensive or luxury product, the trial period needs to be longer to allow buyers have more time to make their purchase decision. The trial period for each city can also be different (e.g., depicted by the grey shade in column 3), depending on the average user activity level in the city. In general, if the users are more active, then the required trial period is shorter. For example, the trial period in city C1 is 8 hours, the trial period in city C4 is 6 hours, and the trial period in city C100 is 4 hours. In addition, the trial period can be pre-determined, or dynamically adjusted as the trial goes on. For example, if the sales volume is extremely low due to some unexpected events, then the trial may be dynamically extended to a longer period to obtain more meaningful trial result.

The trial result for city C1, C4, and C100 is recorded in column 3. Those numbers are then used to predict the sales volume for a longer sales period (e.g., three days) in each city. For example, in city C1, 100 items are sold during the trial for a period of 8 hours, the predicted sales volume for a three-day sale in C1 is 800 items. In city C4, 20 items are sold during the trial for a period of 6 hours, the predicted sales volume for a three-day sale in C4 is 50 items. Similarly, in city C100, 90 items are sold during the trial for a period of 4 hours, the predicted sales volume for a three-day sale in C100 is 700 items. The prediction can be done by a certain algorithm based on factors including: city information, product information, time/season factor, historic sales data, and user activity level and demographic information associated with the selected city.

Among the above factors, a very important factor to be used for the sales volume prediction is the historic sales data of the same product or related product in each trial city. FIG. 4 is a diagram of past sales data of a product P′ in city C1 and C100. Product P′ is in the same category as product P and thus its sales data is representative for product P. FIG. 4 illustrates the sales volume of P′ every 4 hours for a period of 72 hours (e.g., 3 days). A dotted line 401 depicts the sales volume of P′ in city C1, while a solid line 402 depicts the sales volume of P′ in city C100. It can be seen that city C1 has a relatively low user activity level in terms of online shopping, and thus line 401 is more flat. On the other hand, city C100 has a relatively high user activity level in terms of online shopping, and thus line 402 is steeper. In other words, for city C100, most of the shopping activity occurred in the first day, while for city C1, the shopping activity is spread more evenly into three days. Based on this information, the relationship between the sales volume during the trial period and the sales volume during the sales period can be more accurately assessed for each city. As a result, the sales volume prediction is more accurate for each city.

While one option is to try product P in every city, another option is to determine a subset of the cities to try, and the subset will enable the online retailer to predict the sales in all the cities. The determination may be based on past sales data for the product or related products in the cities, and other information such as market data and human experience. For example, for product P that is in a particular category (e.g., women's clothing), past sales indicates that the sales in city C1 and C2 usually maintain a 1:2 ratio. Based on this information, the online retailer decides to try the product only in city C1. Referring back to FIG. 3, if a short trial indicates that 800 items of product P could be sold for 3 days in C1, the online retailer can deduce that 1600 items could be sold in C2, and the product is featured in both cities. Similarly, if the sales in C4 can be used to predict the sales in C5 (e.g., the sales in C4 and C5 maintain a 5:6 ratio), the online retailer only needs to pick C4 to try. If a short trial indicates that 50 items of product P could be sold for 3 days in C4, the online retailer can deduce that 60 items could be sold in C5, and the product is not featured in either city because the predicted sales volume is too low.

Based on the prediction result, the online retailer can make decision on which cities will have the product featured for targeted selling for a longer sales period. For example, if the predicted sales volume is over 500, then the product will be featured, otherwise the product will not be featured. In the example of FIG. 3, column 5 indicates that city C1, C2, and C100 are the three cities that will feature the product for a three-day targeted selling. Column 6 of FIG. 3 lists the actual sales volume at the end of the three-day period. Since the prediction is based on real trial, and the prediction can be conservative, the sales in most cities should meet the target. In case some cities do not meet the sales target, such as city C100 (100 short), the online retailer can either extend the sale in city C100 for a longer period, or move the unsold inventory to another city that has sold out the product.

Another variation of the first embodiment of merchandise selection and trial process is to sell the product in all cities (trial selection phase) as a regular sale (trial phase), and feature the product again in selected cities (targeted selling phase). In this scenario, the product is sold in all the cities for the regular sales period (e.g., three days). When the regular sale is over, the company can pick the cities where the product sold well, and feature the product in those cities again at a later time.

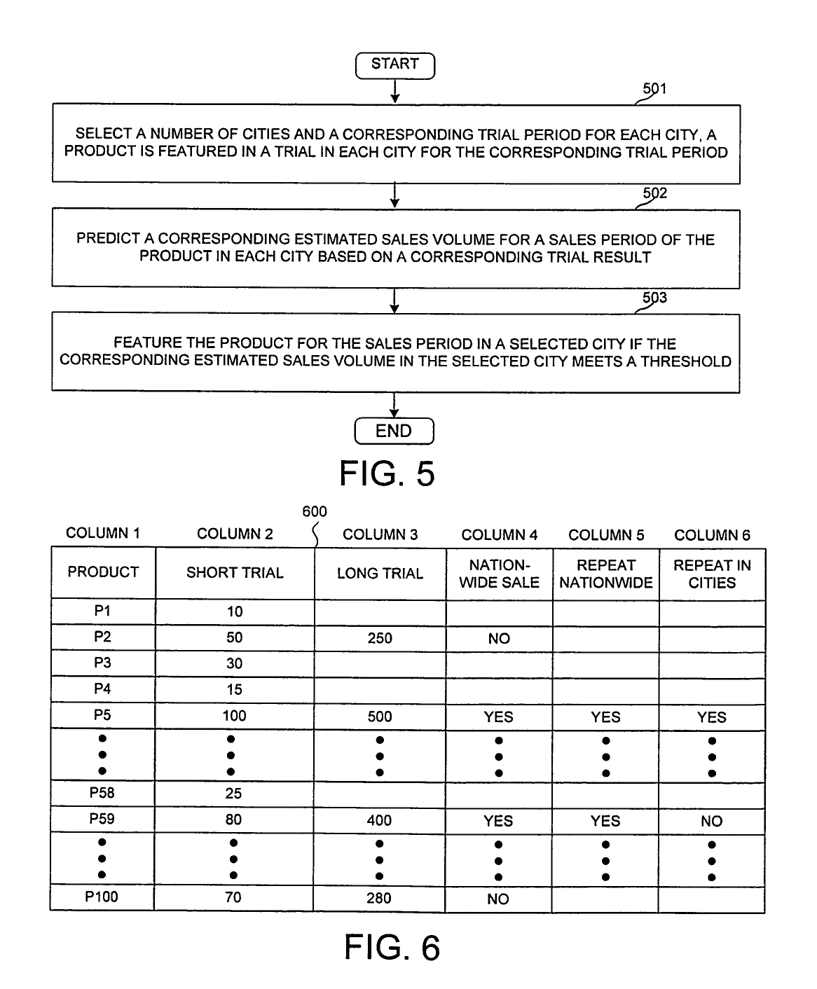

FIG. 5 is a flow chart of a method of selecting the best-selling cities for a certain product as illustrated in FIG. 3. In step 501, an online group-buying company selects a number of cities and a corresponding trial period for each city. A given product P is featured in a trial in each city for the corresponding trial period. In step 502, the group-buying company predicts a corresponding estimated sales volume for a regular sale period of the product P in each city. The prediction is done based on the trial result and past sales data. In step 503, the group-buying company features the product for regular sales period in a selected city if the estimated sales volume in the selected city meets a predetermined threshold value.

FIG. 6 is a table 600 that illustrates multiple phases in a second embodiment of a novel merchandise selection and trial process. In the second embodiment, the merchandise selection and trial process is used to determine the best products to be sold in certain cities. In the example of table 600, an online retailer decides to select the best products from one hundred products P1 to P100 to sell, and each row represents a product. The first column lists the product name, the second column lists the trial result from a first short trial period, the third column lists the trial result for a second long trial period, the fourth column lists the selected products for nationwide sale, the fifth column lists the selected products for extended nationwide sale, and the sixth column lists the selected products to be repeatedly featured in certain cities.

As illustrated in FIG. 6, the online retailer has one hundred products P1 to P100, from which the company wants to pick a small subset of best ones to sell. The online retailer first selects a few cities to do the trial for a very short period of time. For example, ten cities are picked out of 500 cities to sell the products from 12 am to 8 am. The number of sold items during the eight hours is listed in Column 2. At 8 am, the bottom ˜90% of the products that do not sell well are removed from the trial, and the remaining ˜10% products are continued in the trial for a relatively longer trial period. For example, products P2, P5, P59, and P100 are featured for a total of two days. The number of sold items during the two days is listed in Column 3. After the two-day period, the top few products, such as P5 and P59 out of the original 100 products are selected to be sold in many cities nationwide, as indicated by column 4. If the nationwide sale is above a certain volume, the products may have further potential and thus may be featured again nationwide at a later time, as indicated by column 5. When the sales volume of a product is below a certain level, the product has reached its limit nationwide. However, the product may still be welcome in some cities. The online retailer thus finds the best-selling cities and check whether the sales in those cities are above a certain level (this level is usually lower than the nationwide level). If so, the product is featured again in those cities, as indicated by column 6 (P5 is featured again in certain cities). As long as the sales volume of the product is above a certain level for some selected cities, the product may be featured repeatedly in those cities.

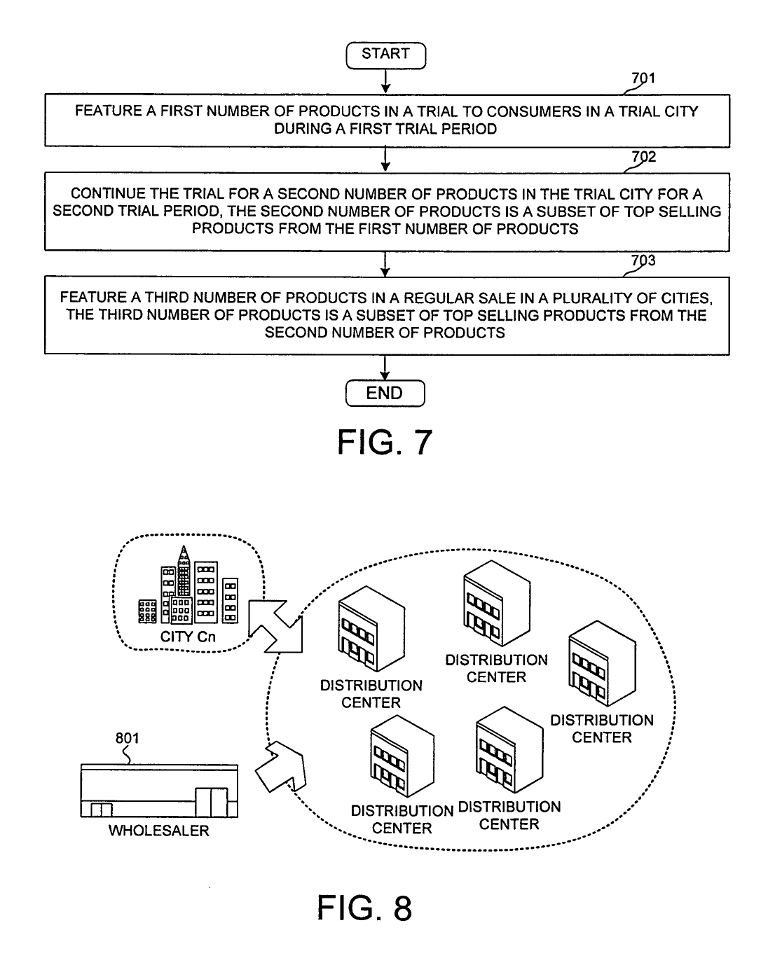

FIG. 7 is a flow chart of a method of selecting the best-selling products for certain cities as illustrated in FIG. 6. In step 701, an online group-buying company features a first number of products in a trial in one or more trial cities for a first short trial period. In step 702, the group-buying company continues the trial for a second number of products in the cities for a second long trial period. The second number of products is a subset of top selling products from the first number of products. In step 703, the group-buying company features a third number of products in a plurality of cities nationwide. The third number of products is a subset of top selling products from the second number of products. If the nationwide sale of a product reaches certain level, then the product can be featured again nationwide. In addition, the product can be featured repeatedly in some best-selling cities after the product has reached its limit nationwide.

The sales volume in each city for a given product is not only related to factors such as product category, time/season, and user activity and demographic information associated with each city, but also closely related to its sales price. Furthermore, while those factors are not easily manipulated for a given product and a particular city, the price factor can be easily adjusted within a certain range. In one embodiment, a product is featured in a first city at the first lower price for a short trial period. If the trial result is much higher than expected, then the same product is featured in a second city at a second higher price for a short trial period. If the online retailer is satisfied with the trial result, then the second price is used to sell the product in other cities. Similarly, the online retailer may lower the price of a product if the trial result is much lower than expected, as long as the lowered price can still bring profit to the online retailer. By selling a product at an optimized price, it ensures that the online retailer can make desirable profit while the product can be supplied with the best quality and service.

The unique platform of online group-buying provides a tool for quickly testing the actual market of different products in different locations. Prediction of the actual market is based on real trial of the same (or similar) product in the same (or similar) location. As a result, such prediction is much more accurate and reliable as compared to traditional prediction method based on experience, market information, and historic sales data. Typically, featuring different products for a very short period of trial time is unrealistic in traditional retailing and standard online retailing. In addition, traditional or standard online retailing does not sell products on a location-based scheme. With more precise sales volume prediction, the online group-buying company can negotiate better terms with its suppliers by making guarantees for a minimum sale. Better prediction will also reduce unsold inventory.

FIG. 8 illustrates one additional advantage of a novel merchandise selection and trial process. Precise sales volume prediction can enhance planning and facilitate optimized distribution of work load and scheduling. In the example of FIG. 8, city Cn is selected to feature a product P for an estimated quantity of Qn. With better prediction of sales volume, the group-buying company can transport the exact amount Qn of product P from wholesaler 801 to distribution centers in city Cn before the sale, and the local delivery team in city Cn can make advanced scheduling of their work load. For additional details of an optimized merchandise distribution system, see U.S. patent application Ser. No. 13/068,217, entitled “System and Method for Merchandise Distribution,” filed on May 4, 2011, the subject matter of which is incorporated herein by reference.

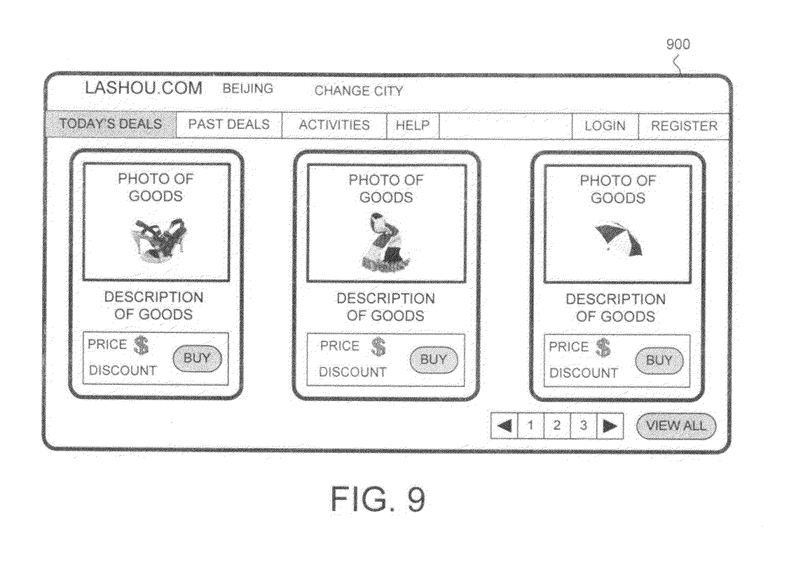

FIG. 9 illustrates another additional advantage of a novel merchandise selection and trial process. Better prediction of sales volume enables better control of the number of products to be featured at city level (optimizing shelf space). In the example of FIG. 9, a group-buying company features a certain number of products (e.g., ten) in its webpage 900 every day. For group buying, the number of products featured online in a certain city at a certain time is limited. This is because buyers will have a harder time finding the product on the website from a large number of products. Also, a product cannot be featured on the website for too long as buyers may become bored seeing the same product every day. By using the trial process, the group-buying company can control the number of the products in each city, and the duration of each product is featured, so that almost all the products online appears to be “hot” and are sold out quickly.

In one or more exemplary embodiments, the functions described above may be implemented in hardware, software, firmware, or any combination thereof. If implemented in software, the functions may be stored on or transmitted over as one or more instructions or code on a computer-readable (processor-readable) medium. Computer-readable media include both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that both can be used to carry or store desired program code in the form of instructions or data structures, and can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies are included in the definition of medium. Disk and disc, as used herein, include compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1. A merchandise selection system, comprising:
a merchandise trial selection module that determines a set of trial parameters for products to be featured on an online group-buying website during a trial period;
a merchandise sales volume prediction module that determines estimated sales volume for a product during a sales period in a selected city, wherein the estimated sales volume is predicted based on a trial volume of the product said during the trial period in a trial city, and wherein the trial period lasts no longer than a few days; and
a merchandise targeted selling module that determines to feature the product for the sales period in the selected city if the estimated sales volume meets a threshold.

2. The system of claim 1, wherein the set of trial parameters comprises city information, product information, price information, and trial period information.

3. The system of claim 1, wherein the estimated sales volume is based on a list of factors comprising city information, product information, time/season factor, sales data, and user activity and demographic information associated with the selected city.

4. The system of claim 1, wherein the set of trial parameters comprises the product and a plurality of trial cities.

5. The system of claim 4, wherein a first trial period is associated with a first trial city, and wherein the second trial period is associated with a second trial city.

6. The system of claim 4, wherein a first price is associated with a first trial city and a second price is associated with a second trial city.

7. The system of claim 1, wherein the set of trial parameters comprises the trial city and a plurality of trial products.

8. The system of claim 7, wherein the merchandise targeted selling module determines a subset of the plurality of trial products to be said in a plurality of selected cities.

9. The system of claim 1, wherein the estimated sales volume of the product is distributed to the selected city before the product is ordered during the sales period.

10. A method, comprising:
selecting a number of cities and a corresponding trial period for each city, wherein a product is featured in a trial to consumer in each city for the corresponding trial period on an online group-buying website, wherein each trial period lasts no longer than a few days;
predicting a corresponding estimated sales volume for a sales period of the product in each city based on a corresponding trial result; and
featuring the product for the sales period in a selected city if the corresponding estimated sales volume in the selected city meets a threshold.

11. The method of claim 10, wherein the prediction is based on a list of factors comprising city information, product information, time/season factor, user activity and demographic information associated with each city.

12. The method of claim 10, wherein the product is featured for a trial period in a first city, and wherein the estimated sales volume is predicted for the product to be said for the sales period in a second city.

13. The method of claim 10, wherein a trial period for each city is fixed before the trial.

14. The method of claim 10, wherein a trial period for each city is dynamically adjusted during the trial.

15. The method of claim 10, further comprising:
distributing the corresponding estimated sales volume of the product to the selected city before the product is ordered during the sales period.

16. The method of claim 10, wherein the product is featured in a first trial at a first price in a first city, and wherein the product is featured in a second trial at a second price in a second city.

17. A method, comprising:
featuring a first number of products in a trial to consumers in a trial city during a first trial period on an online group-buying website, wherein the first trial period lasts no longer than a few days;
continuing the trial for a second number of products in the trial city during a second trial period on the group-buying website, wherein the second number of products is a subset of top selling products from the first number of products; and
featuring a third number of products in a regular sale in a plurality of cities, wherein the third number of products is a subset of top selling products from the second number of products.

18. The method of claim 17, wherein the third number of products are repeatedly featured in the plurality of cities if a total sales volume is above a threshold level.

19. The method of claim 17, wherein a selected product from the third number of products is repeatedly featured in a selected city from the plurality of cities if a sales volume of the selected product maintains a threshold level in the selected city.

20. The method of claim 17, wherein an optimized number of top selling products are featured for regular sale in the trial city each day via the first and the second trial periods.
